(19) United States
(12) Patent Application Publication
(10) Pub. No.: US 2026/0054616 A1
(43) Pub. Date: Feb. 26, 2026

(54) Hughes Ready Indicator Infant car seat

(71) Applicant: Lisa Shonta Calender, Pearl, MS (US)

(72) Inventor: Lisa Shonta Calender, Pearl, MS (US)

(21) Appl. No.: 18/814,458

(22) Filed: Aug. 23, 2024

(51) Int. Cl. B60N 2/26; B60N 2/28

(52) U.S. Cl. CPC B60N 2/269; B60N 2/272; B60N 2/2845

(57) ABSTRACT

The Hughes Ready Indicator Infant Car Seat is an innovative solution designed to enhance safety and convenience for parents and caregivers. This car seat features an integrated readiness indicator system that uses smart sensors to ensure the seat is correctly installed and the infant is securely fastened. The indicator provides visual and auditory alerts, guiding users to achieve proper installation and fit every time, thereby reducing the risk of incorrect usage, which is a common issue with traditional car seats. The seat also incorporates advanced materials and ergonomic design to provide maximum comfort and protection for infants during travel. Additionally, the system is compatible with various vehicle models, making it versatile and user-friendly. By combining cutting-edge technology with practical design, the Hughes Ready Indicator Infant Car Seat sets a new standard in child safety and ease of use, offering parents peace of mind on the road.

### BACKGROUND

Traveling with babies parents face alot of problems like injury and death risk is always found for infants in the event of a crash, infants are so small that they cannot adjust their position which is dangerous for them.

To avoid such issues infants car seat are builded as they protect infants in the event of a crash by absorbing impact forces and reducing the risk of injury or death. Infant car seats ensure that babies are positioned safely and comfortably, providing necessary support to their developing bodies. Many infant car seats are designed to be easily transferred between cars and strollers, making transportation simpler for parents.

Hughes Ready Indicator Infant Car Seat have LED touch screen for adjustment, it activate an emergency respondent in emergency condition, when temperature is high or accident occur it send signal to parents.

### SUMMARY OF INVENTION

The Hughes Ready Indicator Infant Car Seat features a built-in safety indicator to confirm correct installation, enhancing the overall safety of infant passengers. This feature ensures the seat is securely positioned, offering peace of mind to parents. The car seat aims to provide reliable protection and ease of use for infants during car travel.

### Description of the Idea

The design offers a system of ensuring the seat is properly installed and the child is properly restrained. The seat is adjustable to any angle to allow a proper positioned level in any motor vehicle. The interactive LED touch screen on the side of the base console alerts the caregiver to any adjustment that need to be made such as tightening the belt straps, securing the fastener or adjusting the angle. Furthermore, the system is set to activate an emergency respondent if the child is left unattended in the vehicle, if the cab of the vehicle reaches critical temperatures or the internal accelerometer detects that a motor vehicle accident has occurred and a light feature build into the handle of the seat for convenience just in case adjustment need to be made. The Hughes Ready Indicator car seat can be adjusted from front to rear facing to grow with your child. There also opportunity for development of 90 degree tilted and booster seat models

### DESCRIPTION OF THE DRAWING

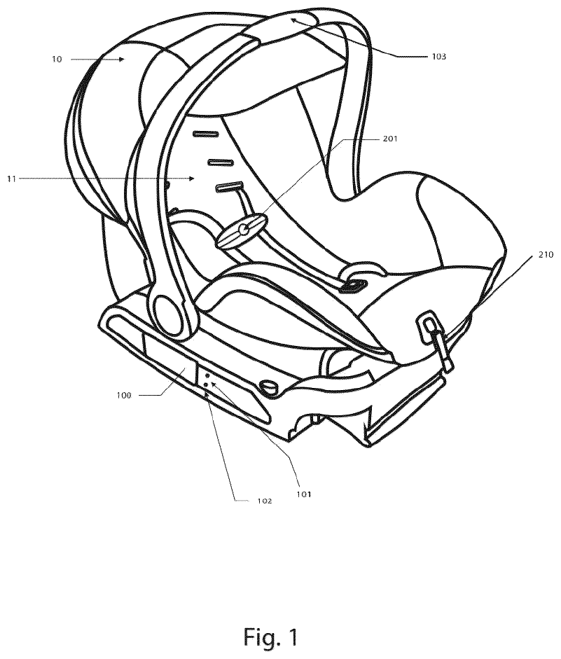

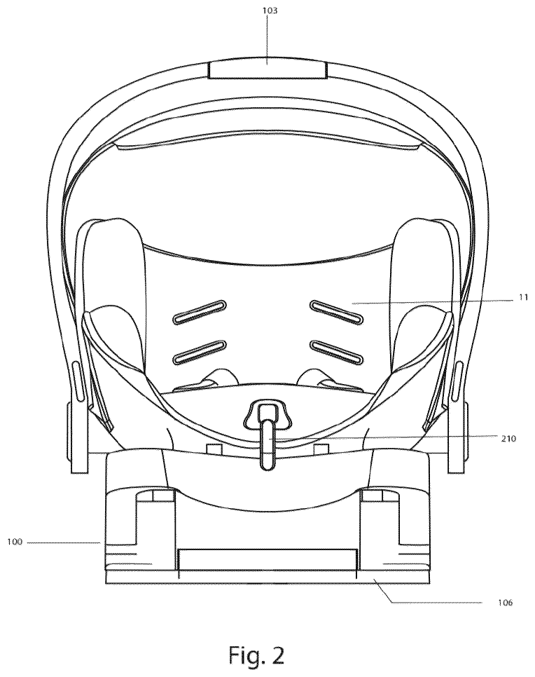

FIG. 1 Shows inside overview of car seat side base;
210 of FIG. 1 shows belt tightening mechanism;
101 if FIG. 1 shows red and green LED's;
102 of FIG. 1 is base of car;
103 of FIG. 2 shows lock in place carry handle;
100 of FIG. 1 shows LED touch screen/alert system;
201 of FIG. 1 shows seat belt sensor alerts if loose or unclasped;
11 of FIG. 1 shows height adjustable belt loop slots to grow with child;
10 of FIG. 1 shows back of seat;

FIG. 2 front facing car seat
103 of FIG. 2 shows lock in place carry handle;
11 of FIG. 2 shows height adjustable belt loop slots to grow with child;
210 of FIG. 2 shows belt tightening mechanism,
106 of FIG. 2 shows back of base of car;
100 of FIG. 2 shows LED touch screen/alert system;

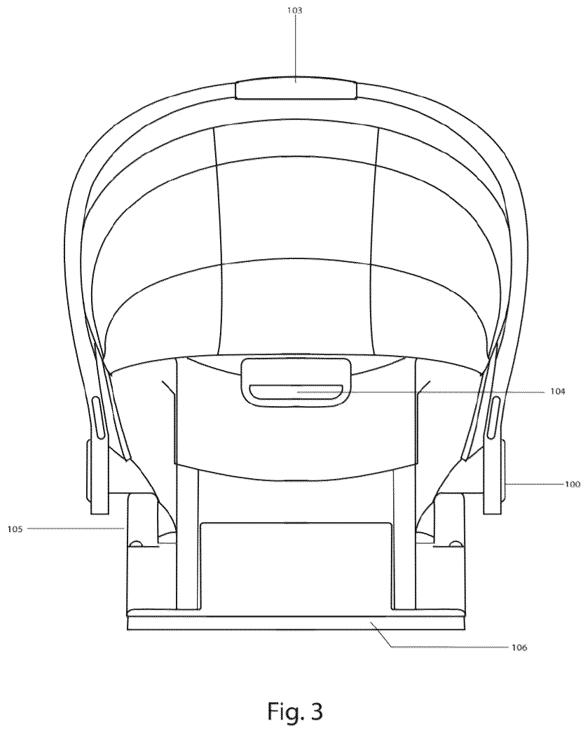

FIG. 3 Shows back car seat with head cover;
103 of FIG. 3 shows lock in place carry handle;
104 of FIG. 3 shows release car seat from base sets off alarm if not properly clicked into place;
105 of FIG. 3 shows height adjustability control;
100 of FIG. 3 shows LED touch screen/alert system;
106 of FIG. 3 shows back of base of car;

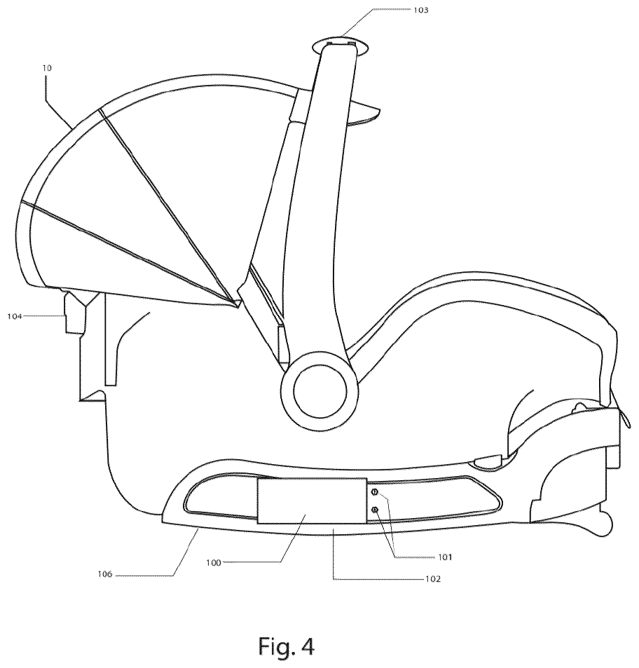

FIG. 4 shows Side view of car seat and LED Screen with extended handle;
103 of FIG. 4 shows lock in place carry handle;
10 of FIG. 4 shows back of seat;
104 of FIG. 4 shows release car seat from base sets off alarm if not properly clicked into place;
106 of FIG. 4 shows back of base of car;
100 of FIG. 4 shows LED touch screen/alert system;
101 of FIG. 4 shows the Touch screen that has red and green LED light;
102 of FIG. 4 shows base of car;

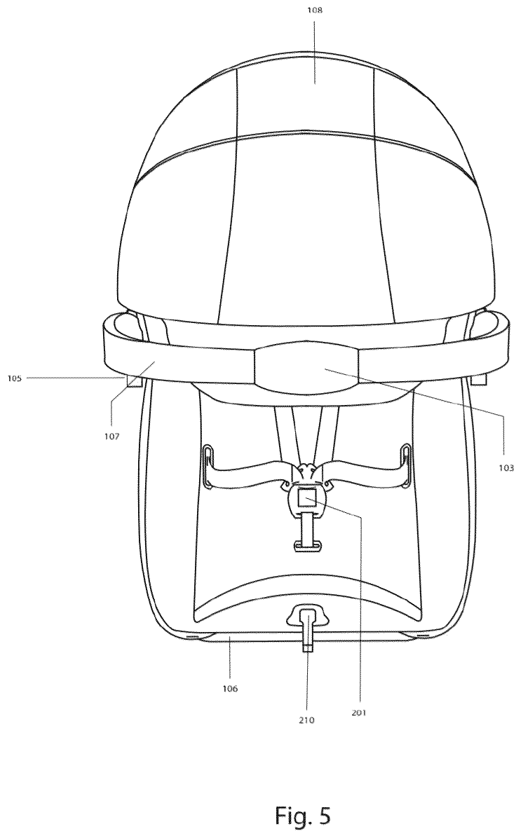

FIG. 5 shows Top overview inside of car seat;
103 of FIG. 5 shows lock in place carry handle;
201 of FIG. 5 shows seat belt sensor alerts if loose or unclasped;
210 of FIG. 5 shows belt tightening mechanism;
105 of FIG. 5 shows height adjustability control;
106 of FIG. 5 shows back of base of car;
108 of FIG. 5 is just the cover that is on top of the car seat;
107 of FIG. 5 is just the handle of the car seat there is a light in the middle of that handle;

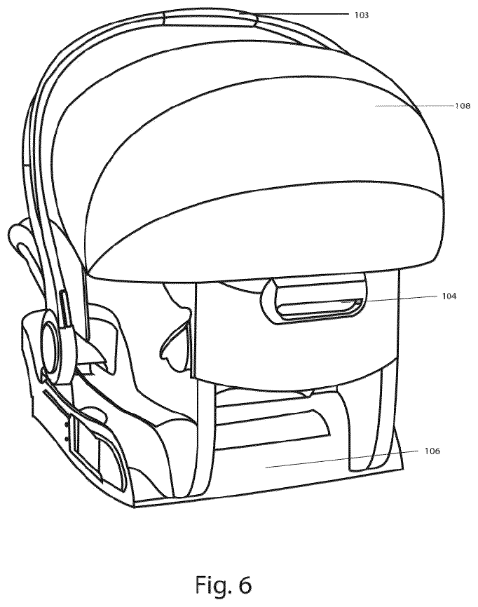

FIG. 6 Back view of car seat and back base;
103 of FIG. 6 shows lock in place carry handle;
104 of FIG. 6 shows release car seat from base sets off alarm if not properly clicked into place;
106 of FIG. 6 shows back of base of car;
108 of FIG. 6 is just the cover that is on top of the car seat.

What is claimed is:

1. A Hughes Ready Indicator Infant Car Seat is comprising of:
Belt;
LED's;
Handle and cover;
Alert system.

2. Belt of claim 1 is adjustable, having tightening mechanism, height adjustable belt loop slots to grow with child.

3. LED of claim 1 is a touch screen at side having LED of green and red colour, at the handle of the car seat there is a light in the middle of that handle.

4. Handle and cover of claim 1 consist of handle which is used to carry the seat, there is also a light on handle; a cover is found to cover the seat to safe the child from weather and other unsuitable conditions.

5. Alert system of claim 1 works when car seat from base sets off alarm if not properly clicked into place; seat belt sensor alerts if belt is loose or unclasped.
